(19) United States
(12) Patent Application Publication
(10) Pub. No.: US 2024/0132775 A1
(43) Pub. Date: Apr. 25, 2024

(54) COMPOSITE QUANTUM DOT, METHOD FOR PREPARING THE SAME, AND METHOD FOR DETECTING METAL ION USING THE SAME

(71) Applicant: National Tsing Hua University, Hsinchu City (TW)

(72) Inventors: Hsueh-Shih CHEN, Hsinchu City (TW); Pin-Ju CHEN, Hsinchu City (TW)

(21) Appl. No.: 18/391,945

(22) Filed: Dec. 21, 2023

Related U.S. Application Data
(62) Division of application No. 17/145,868, filed on Jan. 11, 2021.

(30) Foreign Application Priority Data
Apr. 29, 2020 (TW) 109114489

(51) Int. Cl. C09K 11/02; C09K 11/08; C09K 11/70; G01N 21/64

(52) U.S. Cl. CPC C09K 11/025; C09K 11/0883; C09K 11/70; G01N 21/643; B82Y 20/00; G01N 2021/6439

(57) ABSTRACT

A composite quantum dot includes a quantum dot and a protecting unit. The quantum dot includes a dot body containing a first layer having a composition of M1A1, and a passivating unit containing a passivating metal ion and bound to the dot body. M1 is one of Zn, Sn, Pb, Cd, In, Ga, Ge, Mn, Co, Fe, Al, Mg, Ca, Sr, Ba, Ni, Ag, Ti and Cu, and A1 is one of Se, S, Te, P, As, N, I and O. The protecting unit adsorbs on the quantum dot and includes an amine compound and/or a primary ammonium salt thereof. A method for preparing the composite quantum dot and a method for detecting metal ions in an analyte aqueous solution using the composite quantum dot, as well as a passivated quantum dot and a preparation thereof, are also disclosed.

### CROSS-REFERENCE TO RELATED APPLICATION

This application is a divisional application of U.S. patent application Ser. No. 17/145,868, filed on Jan. 11, 2021, which claims priority of Taiwanese Invention Patent Application No. 109114489, filed on Apr. 30, 2020. The entire content of each of the U.S. and Taiwanese Patent applications is incorporated by reference herein in its entirety.

### FIELD

The disclosure relates to a quantum dot, a method for preparing the same and a method for detecting metal ions using the same, and more particularly to a composite quantum dot, a method for preparing the same, and a method for detecting metal ions using the same.

### BACKGROUND

Quantum dots have been widely applied in various fields and devices (e.g., light-emitting diodes, solar cells, and bioimaging) due to their unique optical properties. CdSe-based quantum dots have attracted more attention since they can be easily synthesized and have excellent optical properties. However, such quantum dots are restricted in use because Cd²⁺ ions thereof are toxic to the environment. Therefore, group III-V quantum dots (e.g., InP quantum dots), which have a relatively low toxicity and a direct bandgap in a visible light region, are gaining importance.

Since InP quantum dot is relatively sensitive and exhibits a low quantum yield, a core-shell structure that includes the InP quantum dot serving as a core, and a single layer (e.g., ZnS) or a double-layered structure (e.g., ZnS/palmitate) serving as a shell and surrounding the InP quantum dot has been developed for maintaining the quantum yield of the InP quantum dot. However, the manufacturing process for such core-shell structure is complicated.

### SUMMARY

Therefore, a first object of the disclosure is to provide a composite quantum dot and a method for preparing the same that can alleviate or eliminate at least one of the drawbacks of the prior art.

According to the disclosure, the composite quantum dot includes a quantum dot, and a protecting unit.

The quantum dot includes a dot body, and a passivating unit including a passivating metal ion that is bound to the dot body. The dot body includes a first layer having a composition of M1A1. M1 is a metal selected from the group consisting of Zn, Sn, Pb, Cd, In, Ga, Ge, Mn, Co, Fe, Al, Mg, Ca, Sr, Ba, Ni, Ag, Ti and Cu, and A1 is an element selected from the group consisting of Se, S, Te, P, As, N, I and O.

The protecting unit adsorbs on the quantum dot and includes one of an amine compound, a primary ammonium salt of the amine compound, and a combination thereof.

According to the disclosure, the method for preparing the abovementioned quantum dot includes a step of reacting a M1-containing precursor with a A1-containing precursor in the presence of a passivating agent and a protecting agent.

M1 of the M1-containing precursor and A1 of the A1-containing precursor have the same definitions as those of the composition of M1A1 as mentioned above.

The passivating agent is selected from the group consisting of a fatty acid salt of a passivating metal and an acetic acid metal salt of the passivating metal, and a combination thereof. The protecting agent is an amine compound.

A second object of the disclosure is to provide a method for manufacturing a passivated composite quantum dot and the passivated composite quantum dot manufactured thereby that can alleviate or eliminate at least one of the drawbacks of the prior art.

According to the disclosure, the method for manufacturing the passivated composite quantum dot includes a step of contacting the aforesaid composite quantum dot with an aqueous solution. The passivated composite quantum dot manufactured thereby has a fluorescence wavelength that is different from that of the composite quantum dot.

A third object of the disclosure is to provide a method for detecting metal ions in an analyte aqueous solution that can alleviate or eliminate at least one of the drawbacks of the prior art.

According to the disclosure, the method includes the steps of:
(a) preparing a first solution that includes a plurality of the aforesaid composite quantum dots;
(b) contacting the analyte aqueous solution with the first solution to form a second solution; and
(c) analyzing fluorescence characteristics of the first solution and the second solution, so as to detect the metal ions in the analyte aqueous solution.

### BRIEF DESCRIPTION OF THE DRAWINGS

Other features and advantages of the disclosure will become apparent in the following detailed description of the embodiment(s) with reference to the accompanying drawings, of which:

FIG. 1 is a plot showing red-shift of absorption peak (shown as “□”) and photoluminescence quantum yield (PLQY) (shown as “O”) of InP quantum dots purified by treating with different aqueous acetone solutions having various water contents;

FIG. 2 is a plot showing absorption spectra (depicted with dotted lines) and photoluminescence (PL) emission spectra (depicted with solid lines) for as-synthesized InP composite quantum dots (as-synthesized InP QDs), acetone-purified InP quantum dots (A-InP QDs), and acetone/water (10 v/v %)-treated InP quantum dots (AW₁₀-InP QDs);

FIG. 3 is a plot showing absorption spectra (depicted with dotted lines) and PL emission spectra (depicted with solid lines) for as-synthesized InP quantum dots, Zn²⁺-passivated InP quantum dots (AW₁₀—InP (Zn²⁺) QDs), and Cd²⁺-passivated InP quantum dots (AW₁₀—InP(Cd²⁺) QDs), as well as transmission electron microscope (TEM) images thereof shown in right insets;

FIG. 4 is a plot showing four Fourier-transform infrared (FTIR) spectra for acetone-purified InP quantum dots (A-InP QDs), Zn²⁺-passivated InP quantum dots (AW₁₀—InP (Zn²⁺) QDs), Cd²⁺-passivated InP quantum dots (AW₁₀—InP(Cd²⁺) QDs), and oleylamine;

FIG. 5 is a bar chart showing relative photoluminescence intensity of the InP QDs in the presence of a respective one of metal ions at a concentration (molar equivalent ratio) of 10 relative to the concentration of A—InP QDs;

FIG. 6 is plot illustrating the PL intensity of the InP QDs in the presence of Zn²⁺ ions with different concentrations (molar equivalent ratio relative to the concentration of A—InP QDs), as well as PLQY thereof shown in left inset;

FIG. 7 is a plot illustrating the PL intensity of the InP QDs in the presence of Cd²⁺ ion with different concentrations (molar equivalent ratio relative to the concentration of A—InP QDs), as well as PLQY thereof shown in left inset; and

FIG. 8 is a plot showing absorption spectra (depicted with dotted lines) and PL spectra (depicted with solid lines) for the InP QDs in the presence of a mixture of Zn²⁺ and Cd²⁺ ions in different equivalent concentration ratios.

### DETAILED DESCRIPTION

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which this disclosure belongs. One skilled in the art will recognize many methods and materials similar or equivalent to those described herein, which could be used in the practice of this disclosure. Indeed, this disclosure is in no way limited to the methods and materials described. For clarity, the following definitions are used herein.

### Composite Quantum Dot and Method for Preparing the Same

According to the present disclosure, a composite quantum dot includes a quantum dot, and a passivating unit.

The quantum dot includes a dot body, and a passivating unit including a metal ion that is bound to the dot body.

The dot boy includes a first layer having a composition of M1A1. M1 of the composition of M1A1 is a metal selected from the group consisting of Zn, Sn, Pb, Cd, In, Ga, Ge, Mn, Co, Fe, Al, Mg, Ca, Sr, Ba, Ni, Ag, Ti and Cu. In certain embodiments, M1 is one of In and Zn. A1 of the composition of M1A1 is an element selected from the group consisting of Se, S, Te, P, As, N, I and O. In certain embodiments, A1 is one of P, Se and S.

The metal ion of the passivating unit may be a di-valent metal ion or a tri-valent metal ion. In certain embodiments, the metal ion of the passivating unit is one of Zn²⁺ ion, Cd²⁺ ion, Pb²⁺ ion, Cu²⁺ ion, Mn²⁺ ion, Fe³⁺ ion, Ni²⁺ ion, Cr³⁺ ion, and combinations thereof.

The protecting unit is adsorbed on the quantum dot, and includes a primary ammonium salt of a amine compound. The protecting unit may further include the amine compound.

The amine compound may be a primary amine. In certain embodiments, the primary amine is an unsaturated fatty amine having carbon atoms that ranges from 12 to 20. In an exemplary embodiment, the amine compound is oleylamine.

The primary ammonium salt may be obtained by, e.g., subjecting the amine compound to a protonation reaction.

The present disclosure also provides a method for preparing the composite quantum dot as mentioned above, which is described as follows.

Specifically, a M1-containing precursor was reacted with a A1-containing precursor in the presence of a passivating agent and a protecting agent, so as to obtain the composite quantum dots of the embodiment.

The M1-containing precursor may be selected from the group consisting of a halide of M1, an acetate of M1, an oxide of M1 and combinations thereof, and M1 has the same definition as that defined for the composition of M1A1 described above. In certain embodiments, the M1-containing precursor is one of a Zn-containing precursor, a Sn-containing precursor, a Cd-containing precursor, an In-containing precursor, a Ga-containing precursor, and a Ge-containing precursor. Examples of the M1-containing precursor suitable for use in this disclosure may include, but are not limited to, indium (III) chloride (InCl₃), indium (III) acetate (InAc₃), indium (III) oxide (In₂O₃), and combinations thereof.

The A1-containing precursor may be an A1-containing amine coordination compound or a hydride of A1, and A1 has the same definition as that defined for the composition of M1A1 described above. In certain embodiments, the A1-containing precursor is one of a Se-containing precursor, a S-containing precursor, and a P-containing precursor. Examples of the A1-containing precursor suitable for use in this disclosure may include, but are not limited to, hexamethylphosphorous triamide ((DMA)₃P), tris (trimethylsilyl)phosphine ((DMS)₃P), and phosphine (PH3). In certain embodiments, the A1-containing precursor is (DMA)₃P having low toxicity.

The passivating agent includes a salt (such as fatty acid salt, acetic acid salt, and a halide salt) of a passivating metal. In certain embodiments, an ion of the passivating metal in the fatty acid salt or the acetic acid salt is a di-valent metal ion or a tri-valent metal ion, such as Zn²⁺, Cd²⁺, Pb²⁺, Cu²⁺, Mn²⁺, Fe³⁺, Ni²⁺, and Cr³⁺. Examples of the passivating agent may include, but are not limited to, zinc stearate (Zn(ST)₂), cadmium stearate Cd(ST)₂, zinc acetate (Zn(Ac)₂), cadmium acetate Cd(Ac)₂, ZnCl₂, ZnI₂, ZnBr₂, and combinations thereof.

The protecting agent may be an amine compound. In certain embodiments, the amine compound is a primary amine. In certain embodiments, the amine compound is an unsaturated or saturated fatty amine having carbon atoms ranging from 12 to 20, such as oleylamine, octadecylamine, hexadecylamine and laurylamine.

Therefore, the M1-containing precursor and the A1-containing precursor are reacted to form the composition of M1A1 of the first layer of the quantum dot, and the passivating agent forms the passivating unit of the quantum dot (i.e., the fatty acid salt or the acetic acid salt of the passivating metal undergoes dissociation to form the passivating metal ion). In addition, the protecting agent (i.e., the amine compound) forms the protecting unit, in which the amine compound is subjected to the protonation reaction with the M1-precursor (such as a halide of M1, an acetate of M1, or an oxide of M1) to form the primary ammonium salt which includes a primary ammonium ion and an counter ion thereof (such as a halide ion from the halide of M1). In certain embodiments, the dot body of the quantum dot of the composite quantum dot may further include a second layer surrounding the first layer, and a third layer surrounding the second layer. The second layer has a composition of M1ₓM2₁₋ₓAl_{y}A2_{1-y}, 0<x≤1, and 0<y≤1. The third layer has a composition of M1A2 or M2A2, and has a base portion and a plurality of spaced-apart protrusion portions that extend from the base portion in a direction away from the second layer. M2 is different from M1, and may be selected from the group consisting of Zn, Sn, Pb, Cd, In, Ga, Ge, Mn, Co, Fe, Al, Mg, Ca, Sr, Ba, Ni, Ag, Ti and Cu. A2 is different from Al, and may be an element selected from the group consisting of Se, S, Te, P, As, N, I and O.

The second layer and/or the third layer are formed by sequentially reacting the quantum dots with the precursor(s) required for forming the second layer and/or the third layer during the synthesis of the composite quantum dot. The relevant reaction parameters for forming the second layer and/or the third layer of the composite quantum dot may be obtained by referring to e.g., U.S. Pat. No. 9,890,329 B2, and may be adjusted according to practical requirements, and therefore detail descriptions thereof are not provided herein for the sake of brevity.

### Passivated Composite Quantum Dot and Method for Preparing the Same

The composite quantum dots as mentioned above are capable of reacting with an aqueous solution to induce surface passivation, thereby obtaining passivated composite quantum dots. Without wishing to be bound by theory, water molecules in the aqueous solution may interact with the composite quantum dots, resulting in the desorption of anions (such as halide ions of the primary ammonium salt) of the protecting unit from a surface of the quantum dot due to ion-dipole interaction, and the passivating metal ion of the passivating unit may substitute for the metal (such as M1) of the dot body while the amine groups from the protecting unit, which serve as surface ligands, are bound to the quantum dot, thereby leading to surface passivation. That is, the passivated composite quantum dots may be obtained by water-induced surface passivation of the composite quantum dots, i.e., contacting the composite quantum dot of the embodiment with the aqueous solution.

In certain embodiments, the aqueous solution is contacted with the composite quantum dot of the embodiment under a temperature ranging from 10° C. to 40° C.

In certain embodiments, the aqueous solution includes a polar solvent and water, and water is present in an amount that is not greater than 50% (v/v) based on the total volume of the aqueous solution. Examples of the polar solvent may include, but are not limited to, acetone and a protic solvent (such as methanol, ethanol, etc.). The aqueous solution may further include a metal ion that is selected from the group consisting of Zn²⁺ ion, Cd²⁺ ion and a combination thereof, which may serve as the source of the passivating metal ion to improve the surface passivation.

The passivated composite quantum dot manufactured thereby has a fluorescence wavelength that is different from that of the (non-passivated) composite quantum dot. With the water-induced surface passivation, the passivated composite quantum dot of this disclosure has an increased photoluminescence quantum yield (PLQY).

### Method for Detecting Metal Ions in an Analyte Aqueous Solution

Since the fluorescence wavelength of the composite quantum dots may change (such as red-shift) after the water-induced surface passivation, the composite quantum dots of this disclosure are expected to serve as a fluorescent probe for detecting metal ions in an analyte aqueous solution.

Therefore, this disclosure provides a method for detecting metal ions in the analyte aqueous solution, which includes the following consecutive steps (a) to (c).

In step (a), a first solution that is water-free and that includes a plurality of the composite quantum dots as mentioned above is prepared.

In step (b), the analyte aqueous solution is contacted with the first solution to form a second solution.

In step (c), fluorescence characteristics of the first solution and the second solution were analyzed, so as to detect the metal ions (such as Zn²⁺ ions and/or Cd²⁺ ions) in the analyte aqueous solution. If metal ions are present in the analyte aqueous solution, such metal ions may act as the passivating metal ions to substitute for the metal of the dot body (such as M1) through the mechanism of the water-induced surface passivation as described above, and the resultant passivated composite quantum dots formed in the second solution may have a fluorescence characteristic that is different from that of the composite quantum dot in the first solution. Each of the fluorescence characteristics of the first solution and the second solution may be a fluorescence intensity, a fluorescence wavelength, or a combination thereof. In certain embodiments, the analyte aqueous solution includes a polar solvent and water, and water is present in an amount that is not greater than 50% (v/v) based on the total volume of the analyte aqueous solution. The analyte aqueous solution may further include an amine compound.

The disclosure will be further described by way of the following example. However, it should be understood that the following examples are solely intended for the purpose of illustration and should not be construed as limiting the disclosure in practice.

### Example 1

### Experimental Materials

1. InCl₃ (purity: 99.999%) and (DMA)₃P (purity: 97%), which respectively serve as a M1-containing precursor and an A1-containing precursor, were purchased from Sigma-Aldrich.
2. Oleylamine (hereinafter referred to as OAm, industrial grade/purity: 70%) which serve as a protecting agent, was purchased from Sigma-Aldrich.
3. ZnCl₂ (anhydrous/purity: 99.95%) which is used to control size distribution of quantum dots, was purchased from Alfa Aesar.

### Preparation of Composite Quantum Dots

In a glove box filled with nitrogen gas (N₂) InCl₃ (10 mg) and ZnCl₂ (300 mg) were added to 5 ml of OAm, followed by stirring to form a mixture. Next, the mixture was degassed in a vacuum at 120° C. for about one hour. After that, the mixture was heated up to 200° C. in an inert gas atmosphere, and then 0.45 mL of (DMA)₃P was immediately injected into the heated mixture to allow the reaction to proceed at 200° C. for 20 minutes. The resultant product was cooled to room temperature, so as to obtain as-synthesized InP composite quantum dots having the Zn²⁺ passivating ions (hereinafter referred to as InP QDs).

It is noted that since (DMA)₃P has a toxicity lower than that of a conventional P-containing precursor for preparing InP QDs, such as tris(trismethylsilyl)phosphine (P(TMS)₃), the InP QDs of the present disclosure can be prepared in a safer and environment friendly manner. In addition, the size distribution of the InP QDs can be decreased by ZnCl₂.

In order to investigate the effect of water on the InP QDs, the InP QDs were purified by treating with acetone (abbreviated as “A”) or an aqueous acetone solution which is prepared by adding various content (i.e., 1 vol %, 2 vol %, 3 vol %, 4 vol %, 5 vol %, 6 vol %, 7 vol %, 8 vol %, 9 vol %, 10 vol %, 20 vol %, 30 vol %, 40 vol % and 50 vol %) of water to acetone (abbreviated as “AWₓ”, in which x corresponds to the added water content). After centrifugation, the resultant precipitate which includes purified A-treated InP QDs (A—InP QDs) or AWₓ-treated InP QDs (AWₓ—InP QDs) was collected, and then suspended in toluene for further analysis.

### Characterization of Quantum Dots of E1

The optical properties of the A—InP QDs and AWₓ—InP QDs as obtained above (10 mM in toluene) were analyzed by a light absorption and photoluminescence (PL) spectroscopy. Red-shift of absorption peak for each of AWₓ—InP QDs was determined relative to the absorption peak of the A—InP QDs (550 nm), and PLQY (%) for each of A—InP and AWₓ—InP QDs was calculated based on the PLQY of standard dyes (i.e., Rhodamine 6G having PLQY of 95% in ethanol; Rhodamine 101 having PLQY of 90% in ethanol).

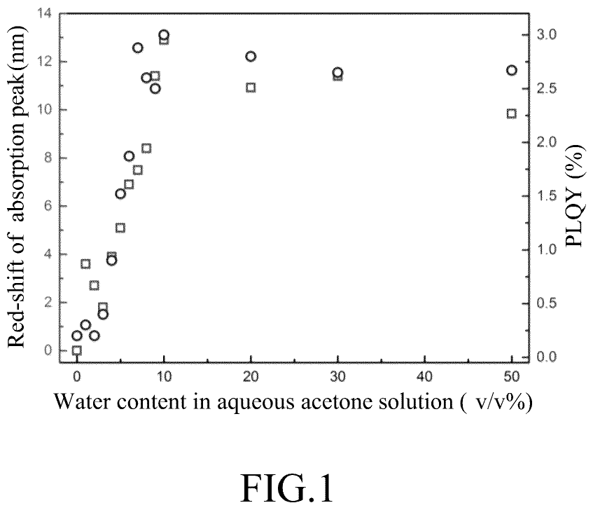

As shown in FIG. 1, when the water content in the aqueous acetone solution increases to about 10 (v/v %) the AWₓ—InP QDs (x is an integer from 1 to 10) have an increased degree of red-shift of absorption peak and an enhancement in PLQY as compared to the A—InP QDs. When the water content in the aqueous acetone solution is greater than 10 (v/v %), PLQY of the AWₓ—InP QDs (x is 20, 30, 40 or 50) slightly decreases as compared to AW₁₀—InP QDs, but is still higher than that of the A—InP QDs.

Based on the above results, the AW₁₀—InP QDs was further selected and subjected to the measurement of normalized absorption and emission spectra (relative to the highest density thus obtained). In comparison, the purified A—InP QDs and the as-synthesized IP QDs were subjected to the same measurement.

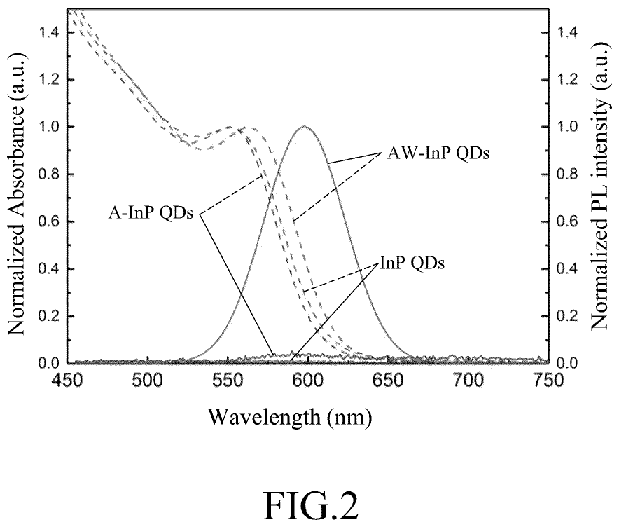

As shown in FIG. 2, the as-synthesized InP QDs and the A—InP QDs have extremely low PL emission intensity. The absorbance (553 nm) and PL emission intensity of the A—InP QDs have no observable change as compared to that of the as-synthesized InP QDs. In contrast, the AW₁₀—InP QDs display a significantly different PL emission spectrum with a highest intensity at a wavelength of 598 nm. In addition, as compared with the absorption spectra of the as-synthesized InP QDs and the A—InP QDs, the AW₁₀—InP QDs have a red-shift in an excitation peak that ranges from 553 nm to 565 nm. Moreover, the as-synthesized InP QDs have a relatively weak PLQY of <1% due to surface traps and dangling bonds, while the AW₁₀—InP QDs have an increased PLQY of 5.1±0.3%.

These results indicate that water treatment may induce surface passivation (e.g., surface ligand exchange or surface modification) of the composite quantum dots of this disclosure, and therefore the resultant passivated composite quantum dots exhibit improved optical properties (such as PLQY and red-shift). It is noted that the PLQY of the QDs can be improved by means of surface passivation. One of conventional ways is to grow a shell layer over the core of the QDs, which is usually conducted at a relatively high reaction temperature (e.g., above 150° C.). However, the passivation of the surface traps of the composite quantum dots of this disclosure can be simply induced by introducing water under room temperature without heating. Moreover, water has been regarded as a complicated impurity in the synthesis of IP quantum dots, and may inhibit the growth and affect the stability of the QDs. However, upon exposure to water, surface trap state of the composite quantum dots of this disclosure can be passivated.

### Example 2

To further understand the mechanism of water-induced surface passivation on the quantum dots of this disclosure, the following experiments are conducted.

Preparation of passivated composite quantum dots First, the A—InP QDs as prepared in Example 1, in which residual precursors are removed by acetone purification, was used to prepare cation-passivated composite quantum dots. Specifically, the purified A—InP QDs were in contact with the aqueous solution includes ZnCl₂ (serving as the source of Zn²⁺ ions for passivation), OAm and water (10 v/v %), so as to induce surface passivation, thereby obtaining the Zn²⁺-passivated InP QDs (hereinafter referred to AW₁₀—InP (Zn²⁺) QDs).

The Cd²⁺-passivated InP quantum dots (hereinafter referred to as AW₁₀—InP (Cd²⁺) QDs) were prepared by procedures similar to those of Zn²⁺-passivated InP QDs, except that the ZnCl₂ is replaced by a Cd-containing substance (e.g., Cd(NO₃)₂ used herein).

### Characterization of Passivated Composite Quantum Dots

The A—InP QDs, AW₁₀—InP (Zn²⁺) QDs and AW₁₀—InP (Cd²⁺) QDs were subjected to the measurement of the normalized absorption and emission spectra.

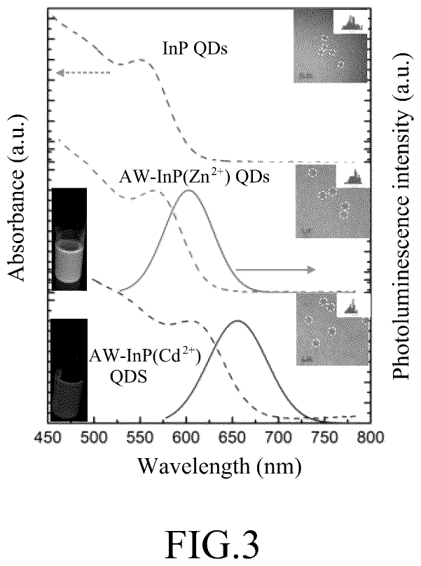

As shown in FIG. 3, the acetone purified A—InP QDs have an absorption wavelength of 553 nm, and an emission wavelength of 604 nm. The AW₁₀—InP(Zn²⁺) QDs have an absorption wavelength of 568 nm, an emission wavelength of 598 nm, and a PLQY of 5.3±0.4%, and these optical features are similar to those of the AW₁₀—InP QDs as determined in FIG. 2. The AW₁₀—InP (Cd²⁺) QDs have an absorption wavelength of 607 nm and a light emission wavelength of 656 nm, and a PLQY of 1.6±0.2%. The results indicate that by reacting with water and passivating cations, the resultant passivated composite quantum dots have red shifts in absorption spectra that range from 10 to 55 nm, and the greatest emission wavelength thereof can even achieve around 650 nm.

The morphology of these InP QDs were also characterized by transmission electron microscope (TEM) analysis. The A—InP QDs display an average particle size of 2.6±0.4 nm, and the AW₁₀—InP(Zn²⁺) QDs and AW₁₀—InP(Cd²⁺) QDs have an average particle size of 2.6±0.3 nm and 2.5±0.4 nm, respectively.

That is, size of the quantum dot particles remains nearly unchanged after surface passivation, suggesting that Zn²⁺/Cd²⁺ ions substitute for In³⁺ ions of the composite quantum dots rather than forming a shell overcoat on the surface of QDs which may cause size variations.

Furthermore, the A—InP QDs, AW₁₀—InP (Zn²⁺) QDs and AW₁₀—InP (Cd²⁺) QDs were subjected to fourier transform infrared spectroscopy (FTIR) analysis, so as to determine the surface ligands thereof. In comparison, oleylamine was subjected to the same analysis.

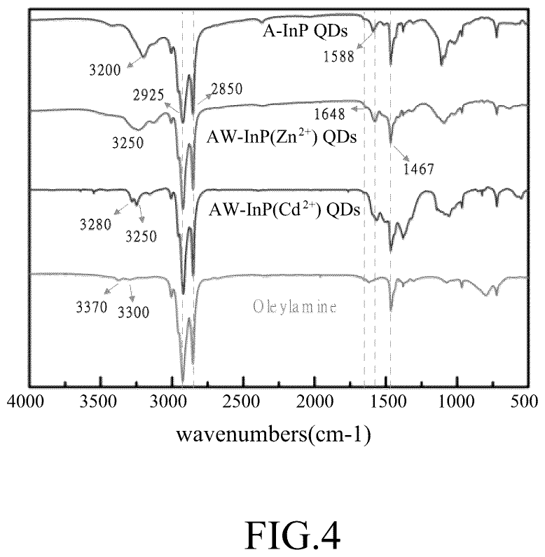

Referring to FIG. 4, all of the A—InP QDs, AW₁₀—InP (Zn²⁺) QDs and AW₁₀—InP (Cd²⁺) QDs show CH₂ and CH₃ symmetric and asymmetric stretching vibrations in the wavenumber range of 2850 cm⁻¹ to 2950 cm⁻¹, CH₂ bending vibration at a wavenumber of 1467 cm⁻¹, and C═C stretching mode as small peak at a wavenumber of 1648 cm⁻¹. These are typical absorption bands for species with hydrocarbon groups, confirming that all InP QDs are covered with long alkyl-chain capping ligands. In addition, all InP QDs show NH₂ scissoring mode at a wavenumber of around 1588 cm⁻¹, indicating that amine-related species are retained on the surface of IP QDs.

In particular, for A—InP QDs, it was observed that one sharp spike is present at a wavenumber of 3200 cm⁻¹ for protonated amine rather than two spikes for primary amine observed from OlAm (N—H) in the wavenumber range of 3100 cm⁻¹ to 3400 cm⁻¹, indicating that the protonated amine groups bind to the surface of the A—InP QDs. In the case of AW₁₀—InP (Zn²⁺) QDs, the corresponding peak shifts to a higher wavenumber of 3250 cm⁻¹ with weaker intensity that seems to indicate two spikes merging together. It is inferred that the amount of protonated amine groups that bind to the surface of the AW-InP(Zn²⁺) QDs is less than that of the A—InP QDs, resulting in a weaker absorbance peak in the range from 3100 cm⁻¹ to 3400 cm⁻¹ for AW-InP(Zn²⁺) QDs. For AW₁₀—InP (Cd²⁺) QDs, two sharp spikes were observed at 3250 cm⁻¹ and 3280 cm⁻¹, which respectively correspond to the antisymmetric and symmetric modes of the N—H stretching peaks of the amine compound. It should be noted that the peaks representing free primary amines are proposed to be located in the wavenumber region of 3300 cm⁻¹ to 3400 cm⁻¹ and will shift toward the lower wavenumbers as amine groups bind to the surface of QDs. Therefore, the Cd-passivated InP QDs show significant primary amine signals as compared to those of the Zn-passivated InP QDs, indicating that more primary amine groups bind thereto. In other words, the surface of the Zn-passivated InP QDs include protonated amine and primary amine groups while the surface of Cd-passivated InP QDs are mostly primary amine groups. These findings can be also used to explain the larger red-shift observed in Cd²⁺-passivated InP QDs of FIG. 3.

Based on the above observation, it is suggested that water-induced surface passivation of the composite quantum dots proceeds through the following proposed mechanism. To be specific, the surface of the as synthesized InP QDs before the acetone/water treatment is initially covered by ion pairs of oleylammonium chloride (OAm⁺Cl⁻), oleylamine and a small amount of Zn²⁺/Cd²⁺ passivating ions. As the InP QDs are in contact with the aqueous acetone solution to induce surface passivation, water molecules in the aqueous solution will interact with Cl⁻ ions to form a hydrogen bonding through ion-dipole interaction, such that the ion pairs of oleylammonium chloride (OAm⁺Cl⁻) detach from the surface of the InP QDs, and meanwhile a portion of the In³⁺ ions of InP QDs is substituted with the Zn²⁺/Cd²⁺ passivating ions to which oleylamine is bound, thereby obtaining the passivated composite quantum dots (i.e., AWₓ-IP QDs) which has an enhancement in PLQY as compared to that of (non-passivated) InP QDs. In other words, the surface of the composite quantum dots (A-IP QDs) having ligands that include the amine compound (OAm), a quaternary ammonium salt of the amine compound (OAm⁺Cl⁻) and passivating metal ions would be changed to amine-dominated surface with an increased content of the passivating metal after the water treatment.

### Example 3

Since water-induced surface passivation for the composite quantum dots occurs within few seconds, the composite quantum dots of this disclosure was subjected to the following tests, so as to determine whether the composite quantum dots may serve as fluorescent probes for detecting metal ions in an analyte aqueous solution.

Specifically, the A—InP QDs as obtained in Example 1 was suspended with toluene, and the resultant water-free solution (i.e., a first solution serving as blank) has 10 mM of the A—InP QDs.

An analyte aqueous solution was prepared by mixing OAm, water (10 v/v %) and one of 18 different metal ions to be detected (namely, Na⁺, K⁺, Ni²⁺, Pb²⁺, NH₄₊, Mg²⁺, Hg²⁺, Zn²⁺, Cd²⁺, Cu²⁺, Cs⁺, Cr³⁺, CO²⁺, Ce³⁺, Ca²⁺, Ba²⁺, Mn²⁺, and Fe³⁺ ions) at a concentration (molar equivalent ratio) of 10 relative to the concentration of A—InP QDs. Each of the analyte aqueous solutions was then added into the first solution to form a respective one of second solutions. The PL emission intensity of the first solution and each of the second solutions under the excitation wavelength of 450 nm were determined.

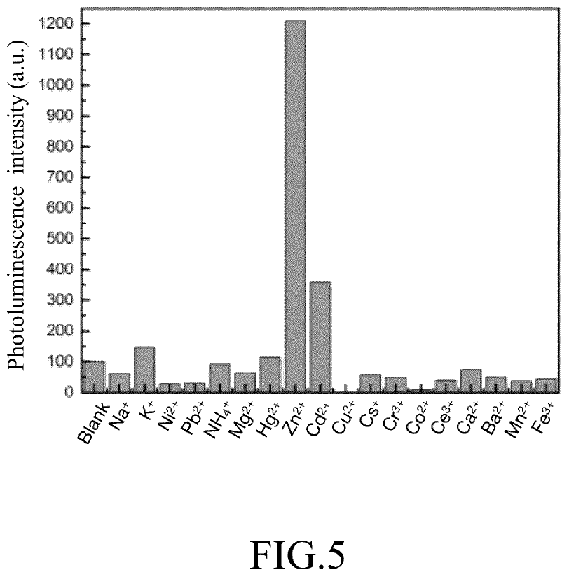

As shown in FIG. 5, the PL intensity for each of the second solutions is different from that of the first solution, indicating that the composite quantum dots of this disclosure can serve as fluorescent probes to detect the metal ions present in the aqueous solution through variation of fluorescence characteristics. In particular, the composite quantum dots of this disclosure are more sensitive to Zn²⁺ and/or Cd²⁺ ions.

Therefore, the fluorescence response of the first solution containing the composite quantum dots of this disclosure as prepared above to Zn²⁺ and/or Cd²⁺ ions with various concentrations (molar equivalent ratio relative to the concentration of A—InP QDs) was further investigated. To be specific, different Zn-containing analyte aqueous solutions with various concentrations (molar equivalent ratio of 0, 0.1, 0.2, 0.6, 1, 2, 3, 5 and 10 relative to the concentration of A—InP QDs) of Zn²⁺ ions and different Cd-containing analyte aqueous solutions with various concentrations (molar equivalent ratio of 0, 0.1, 0.2, 0.6, 1, 2 3, 5 and 10 relative to the concentration of A—InP QDs) of Cd²⁺ ions were prepared. In addition, different Zn/Cd-containing analyte aqueous solutions with Zn²⁺ and Cd²⁺ ions in equivalent concentration ratios of 3:0, 2:1, 1.5:1.5, 1:2 and 0:3 were also prepared. Each of the analyte aqueous solutions was then added into the first solution to form a respective one of second solutions. The optical properties of each of the second solutions under the excitation wavelength of 450 nm were determined.

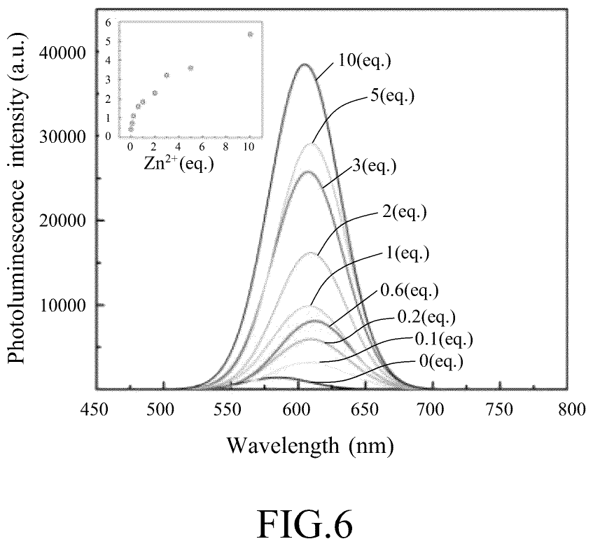

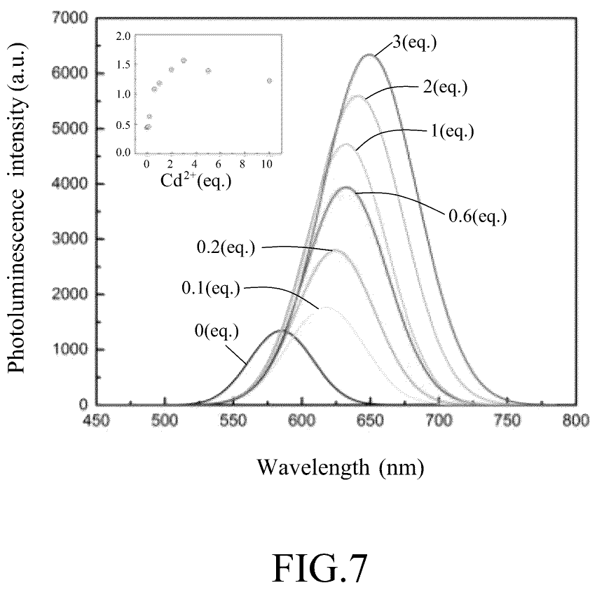

Referring to FIG. 6, the PL intensity of the second solution gradually increases with an increased concentration (molar equivalent ratio relative to the concentration of A—InP QDs) of Zn²⁺ ions. When the concentration of the Zn²⁺ ions in the analyte aqueous solution is 10, the second solution exhibits a maximum PLQY of 5.3%. Similarly, referring to FIG. 7, the PL intensity of the second solution gradually increases with an increased concentration (molar equivalent ratio relative to the concentration of A—InP QDs) of added Cd²⁺ ions. When the concentration of the added Cd²⁺ ions is 3 eq, the second solution exhibits a maximum PLQY of 1.6%. Additionally, Zn²⁺ and Cd²⁺ ions can be distinguishable by red-shift of emission peaks, in which the red-shift ranges from 10 nm to 15 nm for Zn²⁺ ions and ranges from 40 nm to 50 nm for Cd²⁺ ions. These results indicate that the composite quantum dots of this disclosure are capable of selective detection of Zn²⁺ and Cd²⁺ in the aqueous solution.

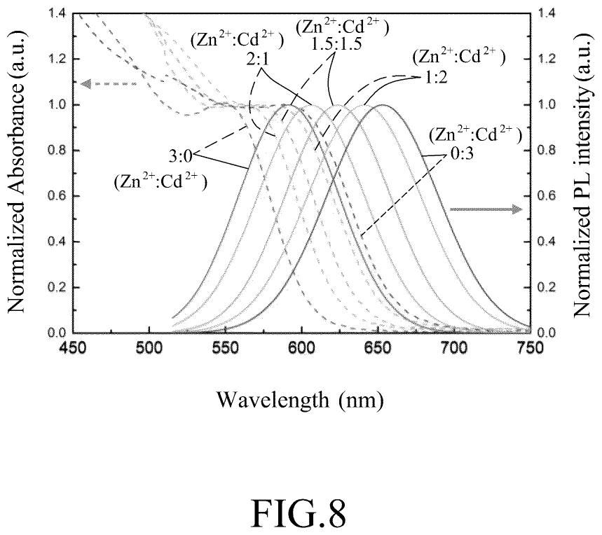

Referring to FIG. 8, the absorbance peak and PL intensity of the second solution change with the different ratios of Zn²⁺ and Cd²⁺ ions. In particular, when the concentration of Cd²⁺ ions increases, the passivated InP QDs in the second solution exhibit an increase in the absorption wavelength and PL emission wavelength (i.e., red-shift). As such, a ratio of the Zn²⁺ and Cd²⁺ ions in the analyte aqueous solution can be determined in accordance with the fluorescence variation of the second solution. Therefore, it is concluded that the composite quantum dots of this disclosure can be used for qualitative and/or quantitative detection of the metal ions.

It should be noted that, the InP QDs can be passivated upon exposure to water and the metal ions (serving as passivating cations), and the surface of the passivated InP QDs thus obtained may include these metal ions incorporated thereon. By varying the type and/or amount of the metal ions, the passivated InP QDs may exhibit tunable optical properties.

In summary, the composite quantum dots of this disclosure is capable of being passivated by reacting with water, in which the metal ions of the passivating unit and the protecting unit are respectively induced to passivate and protect the surface thereof, thereby obtaining the passivated composite quantum dots having improved optical properties (such as improved PLQY, and red-shift of fluorescence wavelength). In addition, due to the difference in fluorescence wavelength between the composite quantum dots and the passivated composite quantum dots, the composite quantum dots can be used to detect the metal ions in the aqueous solution.

In addition, by virtue of the composite quantum dots that have passivating effect induced by water, the present disclosure provides a method for effectively detecting the metal ions in the analyte aqueous solution.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for preparing a composite quantum dot, comprising a step of reacting a M1-containing precursor with a A1-containing precursor in the presence of a passivating agent and a protecting agent,
wherein M1 is selected from the group consisting of Zn, Sn, Pb, Cd, In, Ga, Ge, Mn, Co, Fe, Al, Mg, Ca, Sr, Ba, Ni, Ag, Ti and Cu; A1 is an element selected from the group consisting of Se, S, Te, P, As, N, I and O; the passivating agent includes a salt of a passivating metal; and the protecting agent is an amine compound.

2. The method of claim 1, wherein the composite quantum dot includes a quantum dot including a dot body and a passivating unit, the dot body including a first layer having a composition of M1A1, the passivating unit including an ion of the passivating metal and being bound to the dot body, and
a protecting unit adsorbing on the quantum dot and including a primary ammonium salt of the amine compound.

3. The method of claim 1, wherein the M1-containing precursor is selected from the group consisting of a halide of M1, an acetate of M1, an oxide of M1, and combinations thereof.

4. The method of claim 1, wherein the A1-containing precursor is selected from the group consisting of amine coordination compound, a hydride of A1 and a combination thereof.

5. The method of claim 1, wherein the salt of the passivating metal is selected from the group consisting of a fatty acid salt of the passivating metal, an acetic acid salt of the passivating metal, a halide salt of the passivating metal, and
combinations thereof.

6. The method of claim 1, wherein the amine compound is a primary amine.

7. A method for manufacturing a passivated composite quantum dot, comprising a step of contacting a composite quantum dot with an aqueous solution, the composite quantum dot including
a quantum dot including a dot body that includes a first layer having a composition of M1A1, and a passivating unit that includes a passivating metal ion and that is bound to the dot body; and
a protecting unit adsorbing on the quantum dot and including a primary ammonium salt of an amine compound,
wherein M1 is a metal selected from the group consisting of Zn, Sn, Pb, Cd, In, Ga, Ge, Mn, Co, Fe, Al, Mg, Ca, Sr, Ba, Ni, Ag, Ti and Cu, and A1 is an element selected from the group consisting of Se, S, Te, P, As, N, I and O.

8. The method of claim 7, wherein the aqueous solution includes a polar solvent and water, and water is present in an amount that is not greater than 50% (v/v) based on the total volume of the aqueous solution.

9. The method of claim 7, wherein the aqueous solution includes a metal ion that is selected from the group consisting of Zn²⁺ ion, Cd²⁺ ion, and a combination thereof.

10. A passivated composite quantum dot, which is manufactured by a method as claimed in claim 7, and which has a fluorescence wavelength that is different from that of the composite quantum dot.

11. A method for detecting metal ions in an analyte aqueous solution, comprising the steps of:
preparing a first solution that includes a plurality of composite quantum dots, each of which includes a quantum dot and a protecting unit, the quantum dot including a dot body that includes a first layer having a composition of M1A1, and a passivating unit that includes a passivating metal ion and that is bound to the dot body, M1 being a metal selected from the group consisting of Zn, Sn, Pb, Cd, In, Ga, Ge, Mn, Co, Fe, Al, Mg, Ca, Sr, Ba, Ni, Ag, Ti and Cu, Al being an element selected from the group consisting of Se, S, Te, P, As, N, I and O, the protecting unit adsorbing on the quantum dot and including a primary ammonium salt of an amine compound;
contacting an analyte aqueous solution with the first solution to form a second solution; and
analyzing fluorescence characteristics of the first solution and the second solution, so as to detect the metal ions in the analyte aqueous solution.

12. The method of claim 11, wherein the analyte aqueous solution includes an amine compound.

13. The method of claim 11, wherein each of the fluorescence characteristics of the first solution and the second solution is selected from the group consisting of a fluorescence intensity, a fluorescence wavelength, and a combination thereof.

14. The method of claim 11, wherein the analyte aqueous solution includes a polar solvent and water, and water is present in an amount that is not greater than 50% (v/v) based on the total volume of the aqueous solution.
